(19) United States
(12) Patent Application Publication
(10) Pub. No.: US 2008/0228876 A1
(43) Pub. Date: Sep. 18, 2008

(54) SYSTEM AND METHOD FOR ONLINE COLLABORATION

(76) Inventor: Byron Johnson, Chicago, IL (US)

Correspondence Address: HOLLAND & KNIGHT LLP, 10 ST. JAMES AVENUE, 11th Floor, BOSTON, MA, 02116-3889, US

(21) Appl. No.: 12/034,937

(22) Filed: Feb. 21, 2008

Related U.S. Application Data
(60) Provisional application No. 60/894,535, filed on Mar. 13, 2007.

(51) Int. Cl. G06F 15/16

(52) U.S. Cl. 709/204

(57) ABSTRACT

A system and method of online collaboration including providing an electronic book accessible by a user. A collaborative forum corresponding to the electronic book may be provided. Access to the collaborative forum may be provided to one or more users of the electronic book.

### CROSS-REFERENCE TO RELATED APPLICATIONS

This application claims the benefit of U.S. provisional patent application Ser. No. 60/894,535, filed Mar. 13, 2007, the entire disclosure of which is incorporated by reference.

### FIELD OF THE INVENTION

The present disclosure relates to learning tools, and more specifically to learning tools incorporating online collaboration.

### BACKGROUND

Many tools and programs exist for helping students learn. Often, these tools and programs involve attending special learning sessions with tutors. In today's busy world in which both parents often work, there exists a need for such tools that are accessible from the home.

Additionally, different students require different types of help. Some students learn best when they can discuss what they have read with other students, though this type of learning is not always available in a traditional classroom setting. There exists a need for a learning tool that enables students to discuss a book or lesson with other students, tutors or teachers in an online forum specific to the book or lesson.

### SUMMARY

According to an implementation, an online collaboration system may include an electronic book accessible by a user. The online collaboration system may also include a collaborative forum corresponding to the electronic book accessible by one or more users of the electronic book.

One or more of the following features may be included. The electronic book may be selected from a user-specific list of electronic books. The electronic book may be capable of being rendered on a personal computing device. The electronic book may be capable of being rendered in at least one of an audio or text based format.

The online collaboration system may include a text selection option, enabling a user to select at least a portion of text from the electronic book. The selected portion of text may be capable of being rendered in the collaborative forum for discussion. The collaborative forum may be enabled by at least one of a text based, audio or video communication.

According to another implementation, a method of online collaboration may include providing an electronic book accessible by a user. A collaborative forum corresponding to the electronic book may be provided. Access to the collaborative forum may be provided to one or more users of the electronic book.

One or more of the following features may be included. The electronic book may be selected from a user-specific list of electronic books. The electronic book may be capable of being rendered on a computing device. The electronic book may be capable of being rendered in at least one of an audio or text based format.

A user may be enabled to select at least a portion of text from the electronic book. The selected portion of text may be rendered in the collaborative forum for discussion. The collaborative forum may be enabled by at least one of a text based, audio or video communication.

According to another implementation, a computer program product residing on a computer readable medium having a plurality of instructions stored thereon which, when executed by a processor, cause the processor to perform operations including providing an electronic book accessible by a user. The computer program product may also include instructions for providing a collaborative forum corresponding to the electronic book. The computer program product may also include instructions for providing access to the collaborative forum to one or more users of the electronic book.

One or more of the following features may be included. The electronic book may be selected from a user-specific list of electronic books. The computer program product may also include instructions for rendering the electronic book on a computing device. The computer program product may also include instructions for rendering the electronic book in at least one of an audio or text based format.

The computer program product may also include instructions for enabling a user to select at least a portion of text from the electronic book. The computer program product may also include instructions for rendering the selected portion of text in the collaborative forum for discussion. The collaborative forum may be enabled by at least one of a text based, audio or video communication.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an online collaboration process coupled to a distributed computing network

FIG. 2 is a flowchart of a process executed by the online collaboration process of FIG. 1.

FIG. 3 is a screen shot of a user interface screen rendered by the online collaboration process of FIG. 1.

FIG. 4 is a screen shot of a user interface screen rendered by the online collaboration process of FIG. 1.

FIG. 5 is a screen shot of a user interface screen rendered by the online collaboration process of FIG. 1.

### DETAILED DESCRIPTION

### System Overview:

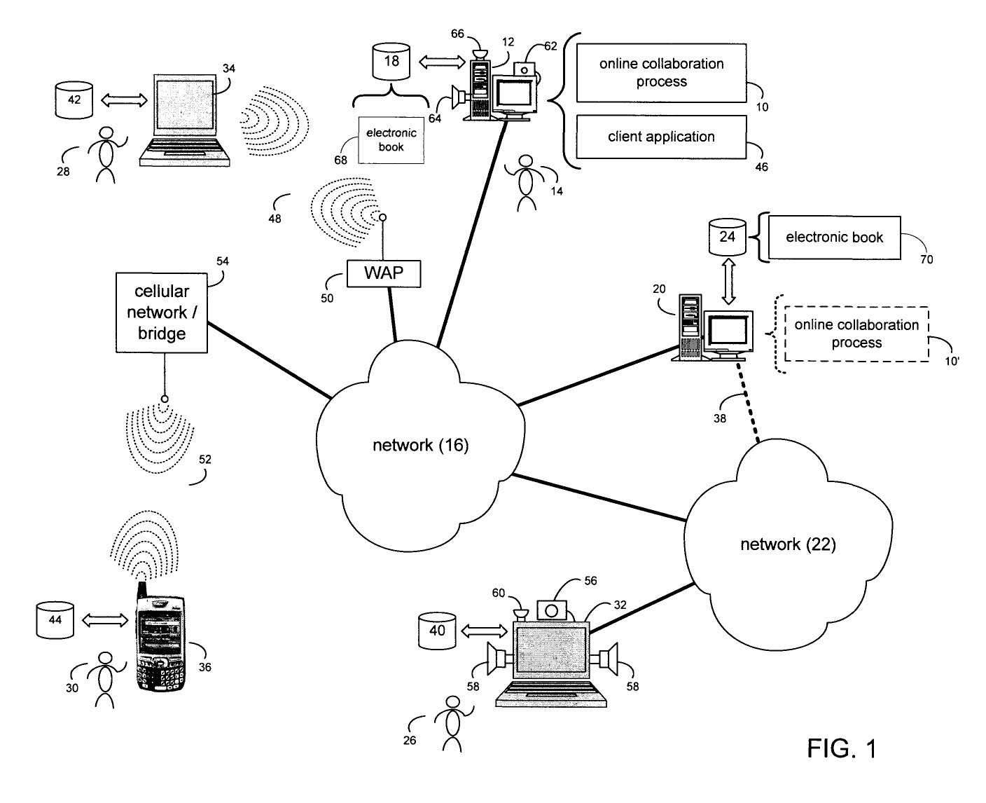

Referring to FIG. 1, there is shown online collaboration process 10 that may provide an electronic book accessible by a user and a collaborative forum corresponding to the electronic book. Online collaboration process 10 may reside on and may be executed by a computing device (e.g., client computer 12). As will be discussed below in greater detail, online collaboration process 10 may enable a user (e.g., user 14) to access the electronic book and the collaborative forum related to that electronic book. The collaborative forum may, for example, allow the user can discuss the electronic book with other users.

Online collaboration process 10 may be a client-side application that resides on and is executed by a computing device, e.g., client computer 12, which may be connected to network 16 (e.g., the Internet). The instruction sets and subroutines of online collaboration process 10, which may be stored on a storage device 18 coupled to client computer 12, may be executed by one or more processors (not shown) and one or more memory architectures (not shown) incorporated into client computer 12. Storage device 18 may include but is not limited to: a hard disk drive; a tape drive; an optical drive; a RAID array; a random access memory (RAM); a read-only memory (ROM); a compact flash (CF) storage device, a secure digital (SD) storage device, and a memory stick storage device.

Additionally/alternatively, online collaboration process 10′ may be a server-based application, as represented in FIG. 1 by server-side online collaboration process 10′ (shown in phantom). Server-side online collaboration process 10′ may reside on and be executed by server computer 20, which may be coupled to network 16. Examples of server computer 20 may include, but are not limited to: a single server computer, a series of server computers, a mini computer, and a mainframe computer, for example. Server computer 20 may execute a network operating system, examples of which may include but are not limited to: Microsoft Windows XP Server™; Novell Netware™; or Redhat Linux™, for example.

Server computer 20 may execute a web server application, examples of which may include but are not limited to: Microsoft IIS™, Novell Webserver™, or Apache Webserver™, that allows for HTTP (i.e., HyperText Transfer Protocol) access to server computer 20 via network 16. Network 16, and/or server computer 20, may be coupled to one or more secondary networks (e.g., network 22), examples of which may include but are not limited to: a local area network; a wide area network; or an intranet, for example.

The instruction sets and subroutines of server-side online collaboration process 10′, which may be stored on a storage device 24 coupled to data server 20, may be executed by one or more processors (not shown) and one or more memory architectures (not shown) incorporated into server computer 20. Storage device 24 may include but is not limited to: a hard disk drive; a tape drive; an optical drive; a RAID array; a random access memory (RAM); a read-only memory (ROM); a compact flash (CF) storage device, a secure digital (SD) storage device, and a memory stick storage device.

As discussed above, the online collaboration process may be a client-side application (e.g., client-side online collaboration process 10), a server-side application (e.g., server-side online collaboration process 10′), or a hybrid client-side/server-side application (e.g., using portions of both client-side online collaboration process 10 and server-side online collaboration process 10′). Accordingly, the manner in which the online collaboration process is accessed may vary depending on whether the online collaboration process is a client-side application, a server-side application, or a hybrid client-side/server-side application.

If a client-side application, one or more users (e.g., users 14, 26, 28, 30) may access the client-side online collaboration process 10 directly through the computing device on which the client-side online collaboration process 10 is executed. Computing devices may include, but are not limited to, client computer 12, notebook computer 32, laptop computer 34, and personal digital assistant 36, for example. As described above, the instruction sets and subroutines of client-side online collaboration process 10, which may be stored on a storage device (e.g., storage devices 18, 40, 42, 44) coupled to the computing device (e.g., client computer 12, notebook computer 32, laptop computer 34, and personal digital assistant 36, respectively), may be executed by one or more processors (not shown) and one or more memory architectures (not shown) incorporated into the computing device. Storage devices 18, 40, 42, 44 may include but are not limited to: a hard disk drive; a tape drive; an optical drive; a RAID array; a random access memory (RAM); a read-only memory (ROM); a compact flash (CF) storage device, a secure digital (SD) storage device, and a memory stick storage device.

Alternatively, server-side online collaboration process 10′ may be accessed by users 14, 26, 28, 30 through network 16 or through secondary network 22. Server computer 20 (i.e., the computer that executes server-side online collaboration process 10′) may be coupled to network 16 through secondary network 22, as illustrated with phantom link line 38.

Computing device, e.g., client computer 12, notebook computer 32, laptop computer 34 and personal digital assistant 36, may execute a client application (e.g., client application 46) to access server-side online collaboration process 10′. Client application (e.g., client application 46) may interface with server-side online collaboration process 10′ and facilitate the bidirectional transfer of data between e.g., client computer 12 and server computer 20. In such an implementation, client-side online collaboration process 10 may be a stand-alone application, or may be a plug-in or applet, that may be executed and/or accessed in the environment of client application 46.

The client application (e.g., client application 46) may be, for example, a web browser (e.g., Microsoft Internet Explorer™ and Netscape Navigator™, for example), a stand alone application, or an applet running within another program (e.g., Microsoft Internet Explorer™ and Netscape Navigator™, for example).

Client computer 12, notebook computer 32, laptop computer 34, and personal digital assistant 36 may each execute an operating system, examples of which may include but are not limited to Microsoft Windows™, Microsoft Windows Mobile™, Redhat Linux™, or a custom operating system.

The various computing devices (e.g., client computer 12, notebook computer 32, laptop computer 34, and personal digital assistant 36) may be directly or indirectly coupled to network 16 (or network 22). For example, client computer 12 is shown directly coupled to network 16 via a hardwired network connection, and notebook computer 32 is shown directly coupled to network 22 via a hardwired network connection.

Laptop computer 34 is shown wirelessly coupled to network 16 via wireless communication channel 48 established between laptop computer 34 and wireless access point (i.e., WAP) 50, which is shown directly coupled to network 16. WAP 50 may be, for example, an IEEE 802.11a, 802.11b, 802.11g, Wi-Fi, and/or Bluetooth device that is capable of establishing wireless communication channel 48 between laptop computer 34 and WAP 50.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows, e.g., mobile phones, computers, and personal digital assistants to be interconnected using a short-range wireless connection.

Personal digital assistant 36 is shown wirelessly coupled to network 16 via wireless communication channel 52 established between personal digital assistant 36 and cellular network/bridge 54, which is shown directly coupled to network 16.

Computing device (i.e., client computer 12, notebook computer 32), which may include one or more media input/output devices, e.g., web-camera 56, 62 audio components, such as speakers 58, 64 and microphone 60, 66 and a real-time messaging system (not shown).

### Online Collaboration Process:

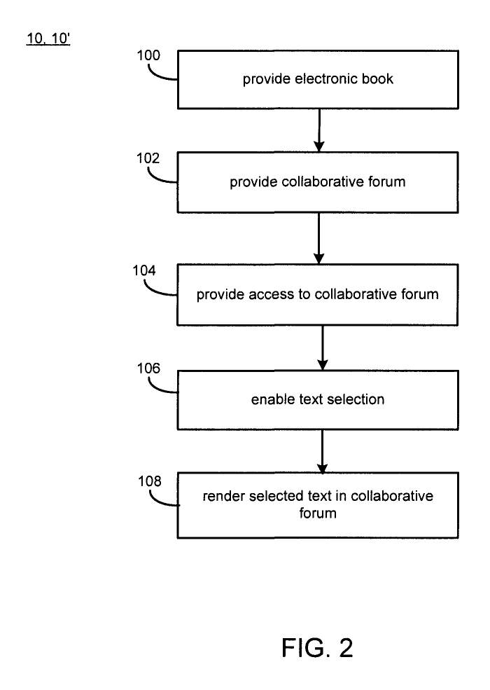

Referring also to FIG. 2, online collaboration process 10, 10′ may provide 100 an electronic book. Additionally, online collaboration process 10, 10′ may provide 102 a collaborative forum. Further, online collaboration process 10, 10′ may provide access to the collaborative forum by one or more users.

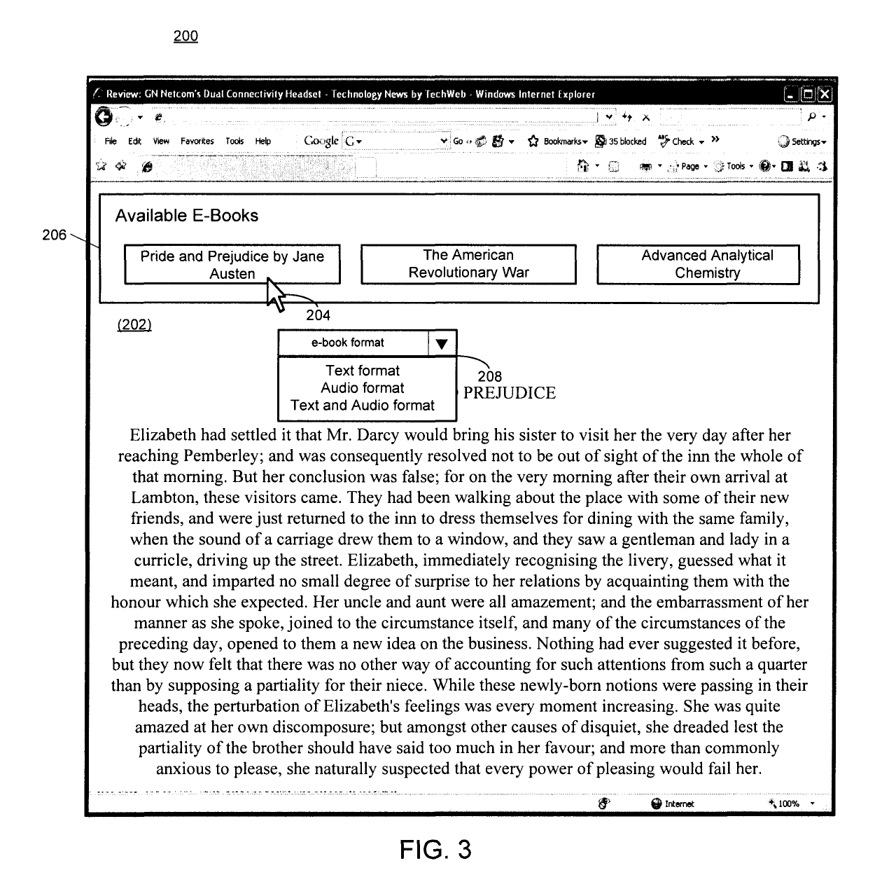

For example, and referring also to FIG. 3, online collaboration process 10, 10′ and/or client application 46 may render user interface screen 200, which may allow a user (e.g., user 14 of client computer 12) to perform various tasks associated with reading and discussing an electronic book. For example, online collaboration process 10, 10′, alone or in conjunction with client application 46, may provide 100 one or more electronic books (e.g., one or more of electronic books 68, 70 which may reside on storage devices 18, 24 respectively). One or more of electronic books 68, 70 may be rendered on a computing device (e.g., client computer 12, notebook computer 32, laptop computer 34, and personal digital assistant 36). Providing 100 access to one or more of electronic books 68, 70 may include displaying at least a portion of one or more of electronic books 68, 70 in electronic book display region 202 of user interface screen 200.

Via user interface screen 200, online collaboration process 10, 10′ and/or client application 46 may allow user 14 to select, e.g., using onscreen pointer 204 controlled by a pointing device (e.g., a mouse; not shown) at least one of the one or more electronic books 68, 70 for viewing (or listening to, in the case of an “audible” book). For example, user 14 may select an electronic book from electronic book list 206 including available electronic books (namely, “Pride and Prejudice”, “The American Revolutionary War”, and “Advanced Analytical Chemistry”) displayed in user interface screen 200. Electronic book list 206 may include a list of books including user-specific lessons, e.g., that may have been chosen as a lesson plan or curriculum for an individual user or class. When user 14 logs in (e.g., by causing computing device 14 and/or server computer 20 to execute online collaboration process 10, 10′ and/or client application 46) electronic book list 206 may be populated with one or more electronic books that a teacher may have chosen for user 14 individually, or for a class as a whole. In this way, electronic book list 206 may be custom-tailored to individual students or for groups of students (e.g., for an entire class). Electronic books 68, 70 may include, for example, a text book or treatise related to a specific topic or it may be a non-fiction book, a best seller or any other work of literature. User 14 may select an electronic book for the purpose of leisure reading, for a school or work assignment, or the like. Additionally/alternatively, electronic book list 206 may include a listing of all electronic books available to user 14. Further, the electronic book list 206 may be populated with a selection of electronic books according to various other mechanisms, for example, from a list such as a best seller list or a recommended reading list.

Upon selecting, via onscreen pointer 204, one of the one or more electronic books from electronic book list 206, online collaboration process 10, 10′ and/or client application 46 may provide 100 the selected electronic book for consumption by user 14, e.g., by rendering the selected electronic book in at least one of an audio or text based format. For example, providing 100 the electronic book may include displaying at least a portion of the selected electronic book in electronic book display region 202 of user interface screen 200.

Additionally/alternatively, while some users may prefer to consume the selected electronic book in text format, other users may find it more beneficial to listen to the electronic book than to read it. Still other users may want to read along while listening to the electronic book. Online collaboration process 10, 10′ may allow user 14 to select a desired format for consuming the electronic book. For example, as discussed above, user 14 may select, via onscreen pointer 204, a desired electronic book from electronic book list 206 displayed in user interface screen 200. In response to user 14 selecting a desired electronic book from electronic book list 206, online collaboration process 10, 10′ and/or client application 46 may provide drop down menu 208. Drop down menu 208 may include various options relating to the manner in which the electronic book may be rendered. For example, drop down menu 208 may include the options “Text Format”, “Audio Format”, and “Text and Audio Format.” User 14 may select, e.g., using onscreen pointer 204, the desired format for consuming the electronic book.

As mentioned above, one or more electronic books (e.g., one or more of electronic books 68, 70) may be rendered in text format by displaying at least a portion of the electronic book in electronic book display region 202 of user interface screen 200. User interface screen 200 may be rendered, e.g., on a display screen of a computing device (e.g., client computer 12, notebook computer 32, laptop computer 34, and personal digital assistant 36). Correspondingly, the electronic book may be rendered in audio format, for example, by providing an audio output to audio components (e.g., speakers 60). Rendering the electronic book in audio format may include, but is not limited to, playing a prerecorded audio file corresponding to the electronic book. Additionally/alternatively, rendering the electronic book in audio format may be accomplished via, e.g., proprietary text-to-audio software, and/or commercially available text-to-audio software (not shown), such as Natural Voices™, available from AT&T.

Online collaboration process 10, 10′ may provide 102 an online collaborative forum corresponding to one or more of electronic books 68, 70. For example, user 14 may wish to discuss the electronic book with other readers of the book, or with a tutor, teacher, or professor, but may not wish to, or may not be capable of, holding such a discussion in person. For example, the other readers, tutor, teacher, or professor may be remotely located from user 14. Online collaboration process 10, 10′ may provide 102 an online interactive collaborative forum, such as a chat room for example, for each of the one or more electronic books 68, 70. The online interactive collaborative forum may enable live discussion of the electronic book. Alternatively, the online interactive collaborative forum may enable user 14 to, e.g., post questions, comments, and the like, to which other users of the online interactive collaborative forum may reply. User 14 may consume any posted replies at a later time.

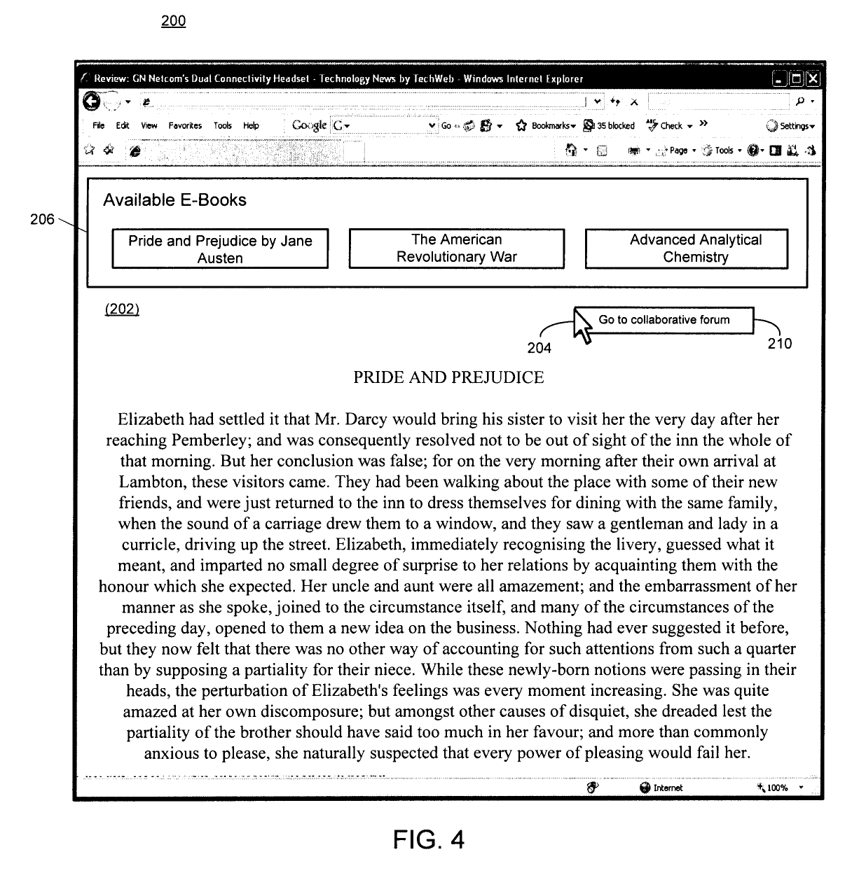

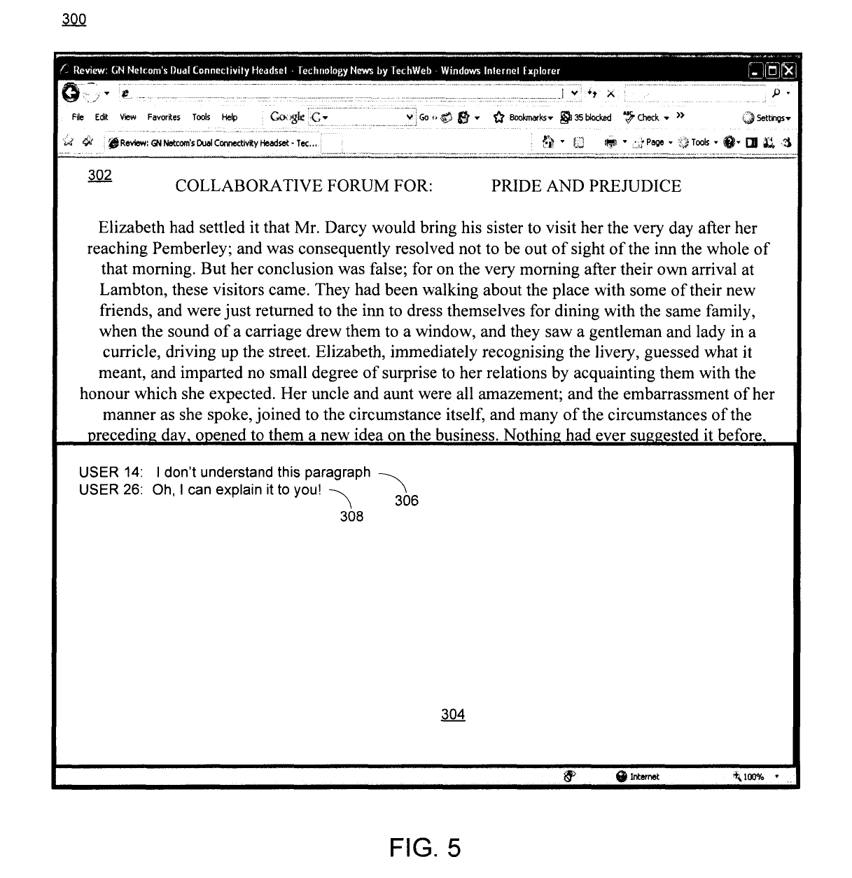

Online collaboration process 10, 10′ may provide 104 access to an online collaborative forum to one or more of the electronic book 68, 70. Continuing with the above-stated example, and referring also to FIG. 4, user 14 may right-click (e.g., via a mouse; not shown) in electronic book display region of user interface screen 200, resulting in online collaboration process 10, 10′ and/or client application 46 rendering popup 210 including the option “Go to collaborative forum”. User 14 may select the option “Go to collaborative forum” using onscreen pointer 204. Referring also to FIG. 5, selecting “Go to collaborative forum” may result in online collaboration process 10, 10′ and/or client application 46 rendering online collaborative forum display screen 300 corresponding to an online collaborative forum for the selected electronic book. Online collaborative forum display screen 300 may be rendered in a separate window, may be rendered in place of user interface screen 200, etc. The online collaborative forum may be, e.g., a website, which may be created and or maintained to allow collaboration relative to the selected electronic book. As shown, online collaborative forum display screen 300 may include text display pane 302 (e.g., which may display at least a portion of the text of the selected electronic book), which may display at least a portion of the selected electronic book.

The online collaborative forum may allow one or more of a text based communication, audio based communication, or video based communication between user 14 and one or more other collaborative users (e.g., user 26). As mentioned above, the communication between user 14 and one or more other collaborative users may include real-time communication, and/or communication via posts which may be responded to and/or consumed at a later time. The audio, video, or text based communication from user 14 may be generated, for example, via web camera 62, microphone 66, and/or a keyboard (not shown) associated with client computer 12. For example, a live video stream of a user may be captured by web camera 62 and may be transmitted through the network, e.g., via network 16 and/or network 22, to user 26 via collaborative forum display screen 300. The live video stream from user 14 may be accessible (e.g., by user 26) via collaborative forum display screen 300, e.g., via server computer 20. For example, a video component of the live video stream may be rendered by client computer 32, and an audio component of the live video stream may be rendered by speakers 58. Similarly, video may be captured by web camera 62 and saved on server computer 20 (e.g., saved on storage device 24). User 26 may subsequently playback the recorded video from server computer 20.

Online collaboration process 10 may enable 106 a user to select at least a portion of text of the one or more electronic books 68, 70 from electronic book display region 202. For example, if there is a specific portion of text, such as a sentence or paragraph, that user 14 wishes to discuss, user 14 may select the text, e.g., using a screen pointer 204, controlled by pointing device, such as a mouse (not shown), e.g., thereby highlighting or otherwise indicating a desired portion of text.

Online collaboration process 10 may render 108 the selected portion of text for discussion in text display pane 302 of collaborative forum display screen 300. The selected portion of text may be rendered 108 in text-based format (e.g., in text display pane 302), audio format or both text and audio format via collaborative forum display screen 300. The format in which the portion of the electronic book is rendered 108 may be determined by user preferences. For example, the user (e.g., user 14) who selected the text may configure online collaboration process 10 to rendered 108 the selected portion of text in text-based format. Alternatively, a user (e.g., user 26) participating in the collaborative forum may configure online collaboration process 10 to render all text selected by other users in audio format when rendered 108 on user 26's computing device (e.g., lap top computer 32).

Collaborative forum display screen 300 may further include discussion pane 304. Discussion pane 304 may allow collaborative interaction between one or more users of the online collaborative forum. For example, user 14 may post one or more questions and/or comments (e.g., comment 306). Similarly, one or more collaborative users (e.g., user 26) may post responses (e.g., response 308), questions or comments of their own, or the like. As such, the one or more users (e.g., user 14 and user 26) may engage in a collaborative interaction relative to the selected electronic book.

A number of implementations have been described. Nevertheless, it will be understood that various modifications may be made. Accordingly, other implementations are within the scope of the following claims.

What is claimed is:

1. A system comprising:
an electronic book accessible by a user; and
a collaborative forum corresponding to the electronic book accessible by one or more users of the electronic book.

2. The system of claim 1, wherein the electronic book is selected from a user-specific list of electronic books.

3. The system of claim 1, wherein the electronic book is capable of being rendered on a personal computing device.

4. The system of claim 3, wherein the electronic book is capable of being rendered in at least one of an audio or text based format.

5. The system of claim 1, further comprising a text selection option, enabling a user to select at least a portion of text from the electronic book, the selected portion of text capable of being rendered in the collaborative forum for discussion.

6. The system of claim 1, wherein the collaborative forum is enabled by at least one of a text based, audio or video communication.

7. A method comprising:
providing an electronic book accessible by a user;
providing a collaborative forum corresponding to the electronic book; and
providing access to the collaborative forum to one or more users of the electronic book.

8. The method of claim 7, wherein the electronic book is selected from a user-specific list of electronic books.

9. The method of claim 7, wherein the electronic book is capable of being rendered on a computing device.

10. The method of claim 9, wherein the electronic book is capable of being rendered in at least one of an audio or text based format.

11. The method of claim 7, wherein the collaborative forum is enabled by at least one of a text based, audio or video communication.

12. The method of claim 7, further comprising:
enabling a user to select at least a portion of text from the electronic book; and
rendering the selected portion of text in the collaborative forum for discussion.

13. A computer program product residing on a computer readable medium having a plurality of instructions stored thereon which, when executed by a processor, cause the processor to perform operations comprising:
providing an electronic book accessible by a user;
providing a collaborative forum corresponding to the electronic book; and
providing access to the collaborative forum to one or more users of the electronic book.

14. The computer program product of claim 13, wherein the electronic book is selected from a user-specific list of electronic books.

15. The computer program product of claim 13, wherein the electronic book is capable of being rendered on a computing device.

16. The computer program product of claim 15, wherein the electronic book is capable of being rendered in at least one of an audio or text based format.

17. The computer program product of claim 13, further comprising:
enabling a user to select at least a portion of text from the electronic book; and
rendering the selected portion of text in the collaborative forum for discussion.

18. The computer program product of claim 13, wherein the collaborative forum is enabled by at least one of a text based, audio or video communication.
